(19) United States
(12) Patent Application Publication
(10) Pub. No.: US 2017/0100686 A1
(43) Pub. Date: Apr. 13, 2017

(54) Liquid Filter

(71) Applicant: Caterpillar Inc., Peoria, IL (US)

(72) Inventors: Patrick W. Savage, Washington, IL (US); Kevin L. Martin, Washburn, IL (US)

(73) Assignee: Caterpillar Inc., Peoria, IL (US)

(21) Appl. No.: 14/881,434

(22) Filed: Oct. 13, 2015

(51) Int. Cl. B01D 35/16; B01D 35/30; B01D 35/00

(52) U.S. Cl. CPC B01D 35/16; B01D 35/005; B01D 35/30; B01D 2201/0453; B01D 2201/304

(57) ABSTRACT

A filter unit includes a top plate, a bottom plate, and a filter medium. The top plate is disposed at a first portion of the filter unit. The bottom plate is disposed at a second portion of the filter unit. The bottom plate includes a plug extending from the bottom plate along an axis of elongation of the filter unit. The filter medium is disposed between the top plate and the bottom plate.

### TECHNICAL FIELD

This patent disclosure relates generally to a liquid filter and, more particularly, to a replaceable filter unit and filter housing.

### BACKGROUND

Engines typically include a filter, such as a fuel filter in a filter housing and the filter may be periodically inspected or replaced. For the filter to work efficiently, it is preferable that an unobstructed fluid path be maintained around the filter. To accomplish this, conventional filters typically include various spacers to keep the filter centered in the filter housing and prevent the filter from resting against an inside wall of the filter housing.

These spacers or other such devices that are part of the filter are typically discarded along with the filter once the filter has reached the end of its service life. In other instances, complicated mechanisms may be utilized to secure a filter within a filter housing. Such complications may increase manufacturing costs and frustration for the end user as well as being susceptible to accelerated wear and/or breakage.

U.S. Pat. No. 6,096,207 (hereinafter “the '207 patent”), entitled “Filter Cartridge Assembly Having a Reusable Support Core Structure,” purports to describe a reusable core structure to support a replaceable filter within a filter housing. However, the core structure of the '207 patent is a complicated part with threaded portions and several parts that are welded together. In addition to the complication of the core structure, the filter the '207 patent must be handled to attach and remove the filter from the core structure. Depending on the fluid being filtered, removing a used filter may be objectionable to the end user.

Accordingly, there is a need for an improved liquid filter to address the problems described above and/or problems posed by other conventional approaches.

### SUMMARY

The foregoing needs are met, to a great extent, by the present disclosure, wherein aspects of an improved liquid filter are provided.

In one aspect, the disclosure describes a filter unit. The filter unit includes a top plate, a bottom plate, a plug, and a filter medium. The top plate is disposed at a first portion of the filter unit. The bottom plate is disposed at a second portion of the filter unit. The plug extends from the bottom plate along an axis of elongation of the filter unit. The filter medium is disposed between the top plate and the bottom plate.

In another aspect, the disclosure describes a housing assembly configured to filter a fluid. The filter housing assembly includes a filter unit and a housing. The filter unit includes a top plate, a bottom plate, a plug and a filter medium. The top plate is disposed at a first portion of the filter unit. The top plate includes a fluid outlet. The bottom plate is disposed at a second portion of the filter unit. The plug extends from the bottom plate along an axis of elongation of the filter unit. A plug gasket is disposed about the plug. The filter medium is disposed between the top plate and the bottom plate. The housing includes a housing bore defined by a cylindrical surface and the plug gasket is configured to form a seal between the cylindrical surface and the plug.

In yet another aspect, the disclosure describes a filter system configured to filter a fluid. The filter system including a filter base and a filter housing assembly. The filter base includes a base inlet, a base outlet, a connection port, and a housing coupler. The filter housing assembly includes a base coupler, a filter unit, and a housing. The base coupler is configured to mate to the housing coupler. The filter unit includes a top plate, a bottom plate, a plug, a plug gasket, and a filter medium. The top plate is disposed at a first portion of the filter unit. The top plate includes a fluid outlet configured to mate with the connection port to form a top locator. The bottom plate is disposed at a second portion of the filter unit. The plug extends from the bottom plate along an axis of elongation of the filter unit. The plug gasket is disposed about the plug. The filter medium is disposed between the top plate and the bottom plate. The housing includes a housing bore is defined by a cylindrical surface and the plug gasket is configured to form a seal between the cylindrical surface and the plug.

It will be understood that the disclosure is not limited in its application to the details of construction and to the arrangements of the components set forth in the following description or illustrated in the drawings. The disclosed device and method are capable of aspects in addition to those described and the disclosed method is capable of being practiced and carried out in various ways. Also, it will be understood that the terminology employed herein, as well as the abstract, are for the purpose of description and should not be regarded as limiting.

Those skilled in the art will appreciate that the conception upon which this disclosure is based may readily be utilized as a basis for the designing of other structures, methods and systems for carrying out the several purposes of the various aspects. Therefore, the claims will be regarded as including such equivalent constructions insofar as they do not depart from the spirit and scope of the various aspects.

### BRIEF DESCRIPTION OF THE DRAWINGS

FIG. 1 is a side view of an exemplary machine, according to an aspect of the disclosure.

FIG. 2 is a cross-sectional view taken axially through a filter housing assembly and a filter base, according to an aspect of the disclosure.

FIG. 3 is an enlarged cross-sectional view of a gasket and retainer at an interface between the filter base and the filter housing of FIG. 2, according to an aspect of the disclosure.

FIG. 4 is a cross-sectional view taken axially through a portion of the filter housing assembly with a plug to center a filter unit in the filter housing, according to an aspect of the disclosure.

FIG. 5 is a cross-sectional view taken axially through a portion of the filter housing assembly with a filter unit having an integrated plug to center the filter unit in the filter housing, according to an aspect of the disclosure.

FIG. 6 is a cross-sectional view taken axially through a portion of the filter housing assembly, a seal, and a top plate of the filter unit, according to an aspect of the disclosure.

FIG. 7 is a cross-sectional perspective view taken axially through the filter housing assembly, according to an aspect of the disclosure.

FIG. 8 is an enlarged, partial cutaway, cross-sectional, perspective view of the gasket and retainer installed on the filter housing of FIG. 7, according to an aspect of the disclosure.

The drawings presented are intended solely for the purpose of illustration and therefore, are neither desired nor intended to limit the subject matter of the disclosure to any or all of the exact details of construction shown, except insofar as they may be deemed essential to the claims.

### DETAILED DESCRIPTION

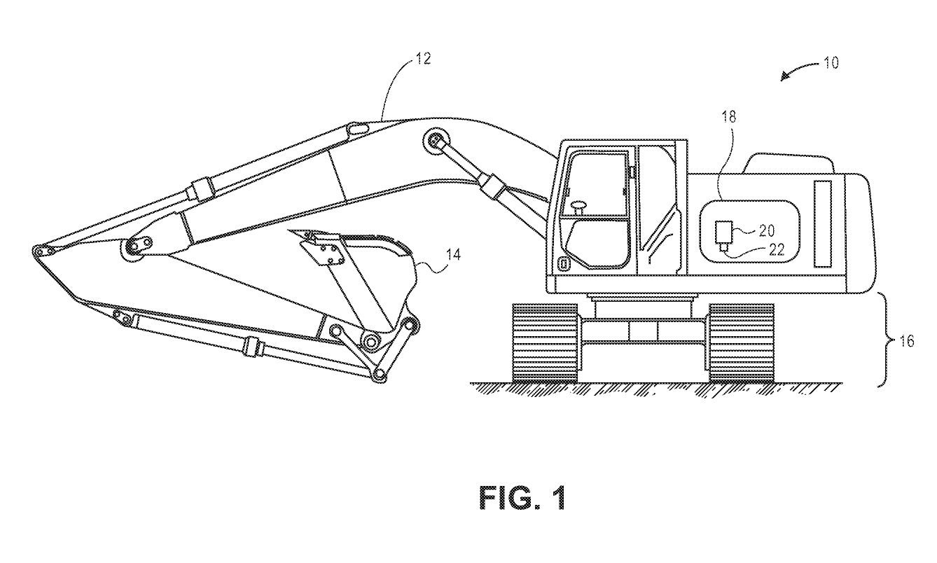

FIG. 1 illustrates an exemplary machine 10 having various systems and components that cooperate to accomplish a task. The machine 10 may embody a fixed or mobile machine that performs some type of operation associated with an industry such as mining, construction, farming, transportation, power generation, or another known industry. For example, the machine 10 may be an earth moving machine such as an excavator (shown in FIG. 1), a dozer, a loader, a backhoe, a motor grader, a dump truck, or another earth moving machine. The machine 10 may include an implement system 12 configured to move a work tool 14, a drive system 16 for propelling the machine 10, a power source 18.

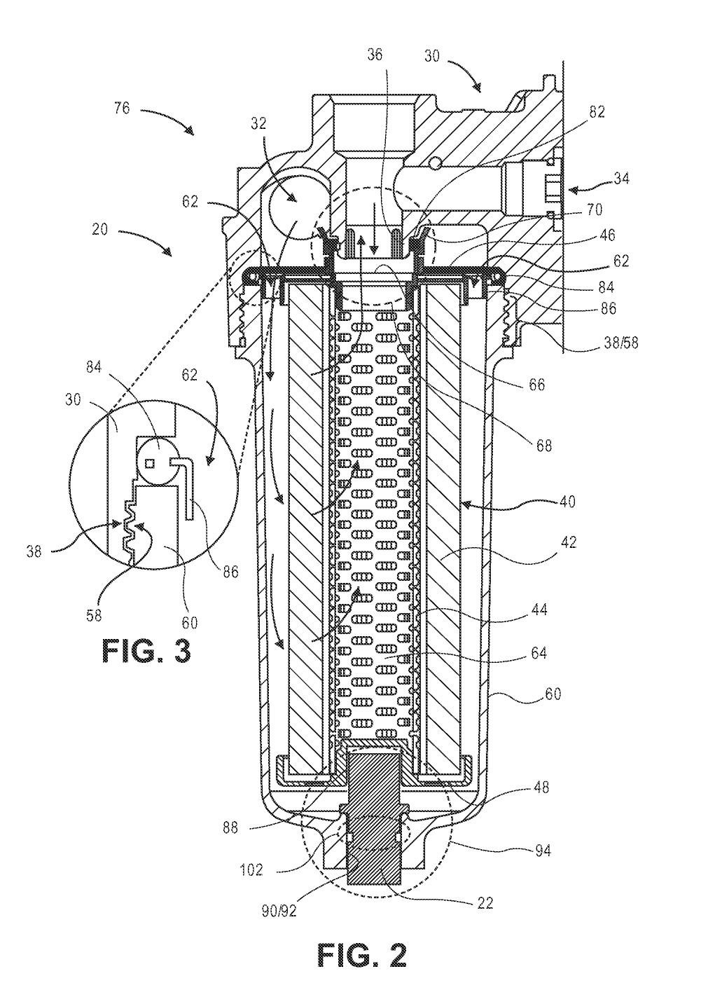

In a particular example, the power source 18 includes an engine configured to combust a fuel such as diesel and the fuel is filtered at a filter housing assembly 20. As fuel passes through the filter housing assembly 20, contaminants such as particulates, debris, water, and the like are filtered out and retained in a filter medium (shown in FIG. 2) and/or collected in the filter housing assembly 20. Periodically, the filter medium and/or fluid in the filter housing assembly 20 may be inspected and if needed, replaced. When replacing the filter medium, the fuel and the contaminants are sometimes drained from the filter housing assembly 20 via a drain (not shown). However, at other times, the fuel may be left in the filter housing assembly 20 or poured out once the filter housing assembly 20 is removed from the power source 18. In these instances a plug 22 may be used to replace the drain.

While the particular example of filtering and separating particulates and water from fuel is discussed in this disclosure, the various embodiments are not limited to filtering and collecting water from fuel, but rather, include any suitable filtering application in which the housing includes a drain. Examples of suitable filtering applications include hydraulic, lubricant, air, or other such filtration systems.

FIG. 2 is a cross-sectional view taken axially through the filter housing assembly 20 and a filter base 30, according to an aspect of the disclosure. As shown in FIG. 2, the filter base 30 includes a base inlet 32, base outlet 34, a connection port 36, and a housing coupler 38. The connection port 36 or stem is configured to draw filtered fuel from a filter unit 40 that is installed in the filter housing assembly 20.

The filter unit 40 includes a filter medium 42 disposed about a center tube 44 and the filter medium 42 is disposed between a top plate 46 and a bottom plate 48. The filter medium 42 may include any suitable material for filtering fluids such as air, fuel, and/or oil. Examples of suitable materials include: paper or other natural material; spun, felted, or woven natural or man-made fibers; polymer foams; and the like. In a particular example, the filter medium 42 includes a card stock of felted polyester fibers. This card stock can be cut, scored, folded and able to retain folds. In particular, the card stock of the filter medium 42 folded into pleats and is wrapped around the center tube 44.

The filter housing assembly 20 is removably secured to the filter base 30 via a base coupler 58 disposed about an opening of a housing 60. In the particular example shown, a threaded portion of the base coupler 58 is configured to mate with a threaded portion of the housing coupler. In general, the housing 60 may include any suitable material such as, for example, metals, plastics, elastomers, and the like. In a particular example, the housing 60 is primarily sheet metal formed into a cylindrical shell and incorporating elastomeric seals. In another particular example, the housing 60 is a cast metal shell to which machined surfaces are subsequently milled and/or elastomeric seals are later added.

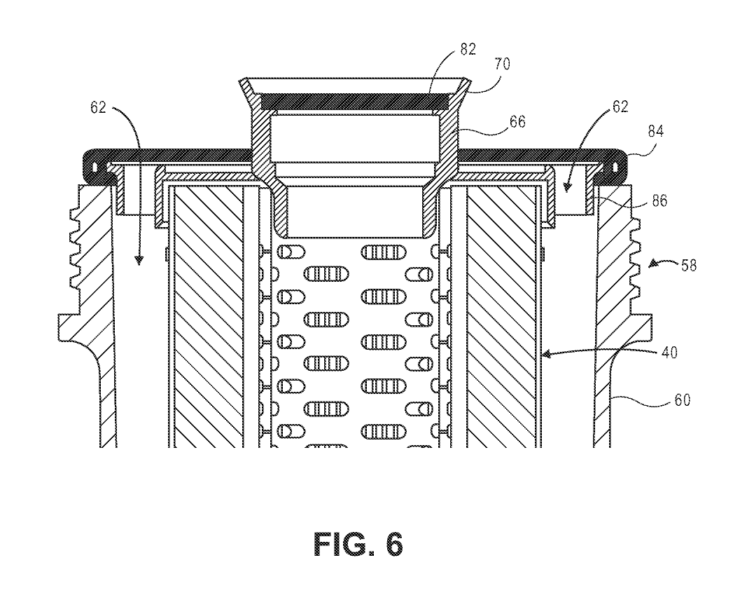

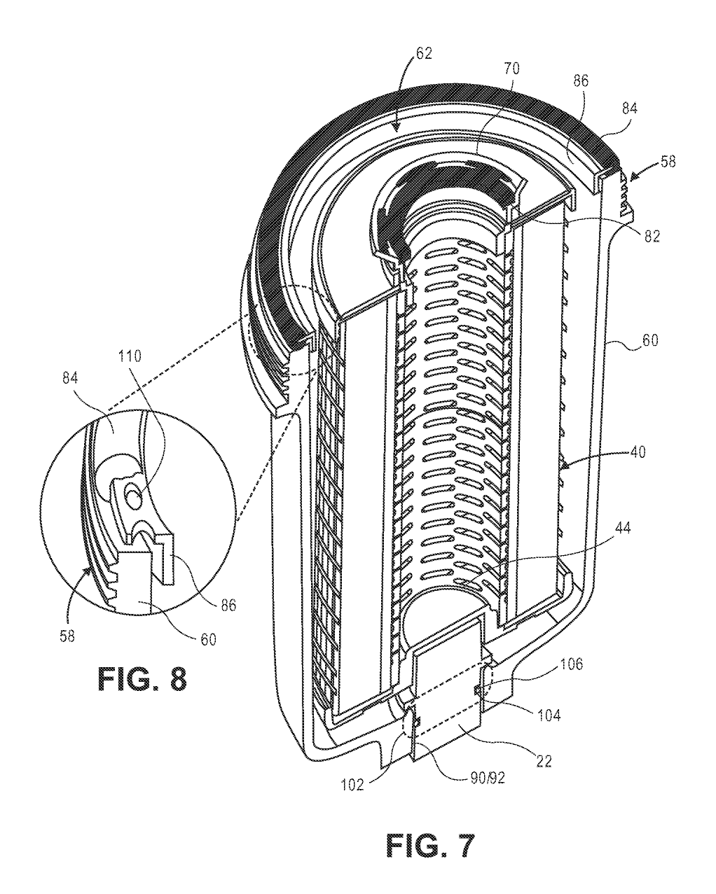

A fuel inlet 62 is located between the opening of the housing 60 and the perimeter of the top plate 46. More particularly, the fuel inlet 62 is an annular opening in fluid communication with the base inlet 32 and the fuel inlet 62 is defined by an inside wall of the housing 60 and the outside perimeter of the top plate 46 (shown particularly in FIG. 7). The fuel inlet 62 is configured to direct the fuel to a first side of the filter medium 42. In the example shown more clearly in FIG. 7, the fuel inlet 62 is an annular opening disposed about the perimeter of the top plate 46. As shown by the arrows indicating flow of the fuel, the fuel is directed towards the perimeter of the housing 60 and then through the filter medium 42 towards an interior chamber 64. Thereafter, the fuel flows out the fuel outlet 66. The fuel outlet 66 is disposed in the top plate 46 and configured to fluidly connect the interior chamber 64 to the connection port 36. In addition, the fuel outlet 66 and connection port 36 may provide a top locator 68 to secure the top plate 46 at a particular position relative to the housing 60. Optionally, the fuel outlet 66 may include an alignment cone 70 disposed about a lip of the fuel outlet 66. If included, the alignment cone 70 is configured to facilitate cooperatively aligning the fuel outlet 66 with the connection port 36 during installation of the filter housing assembly 20 with the filter base 30. As shown in FIGS. 2 and 6, the alignment cone 70 is shaped to guide or funnel the connection port 36 into the fuel outlet 66. The fuel outlet 66 may include an outlet seal 82 configured to mate and form a seal with the connection port 36.

Together, the filter housing assembly 20 and the filter base 30 shown in FIG. 2 form a filter system 76 configured to filter fuel or other fluid. As described herein, the filter unit 40 is located within the filter housing assembly 20 via the connection port 36 and the plug 22. In this manner, the top plate 46 and bottom plate 48 may be simplified and the fuel inlet 62 may allow a greater flow rate than conventional filter systems.

To generate a seal and prevent or reduce leaks between the filter base 30 and the filter housing assembly 20, a gasket 84 may be disposed between the housing coupler 38 and the base coupler 58. In the example shown in greater detail in FIG. 3 and also in FIGS. 7-8, the gasket 84 is secured to a gasket sleeve 86. The gasket sleeve 86 is configured to slide into the housing 60 telescopically to locate the gasket 84 about the perimeter of the base coupler 58.

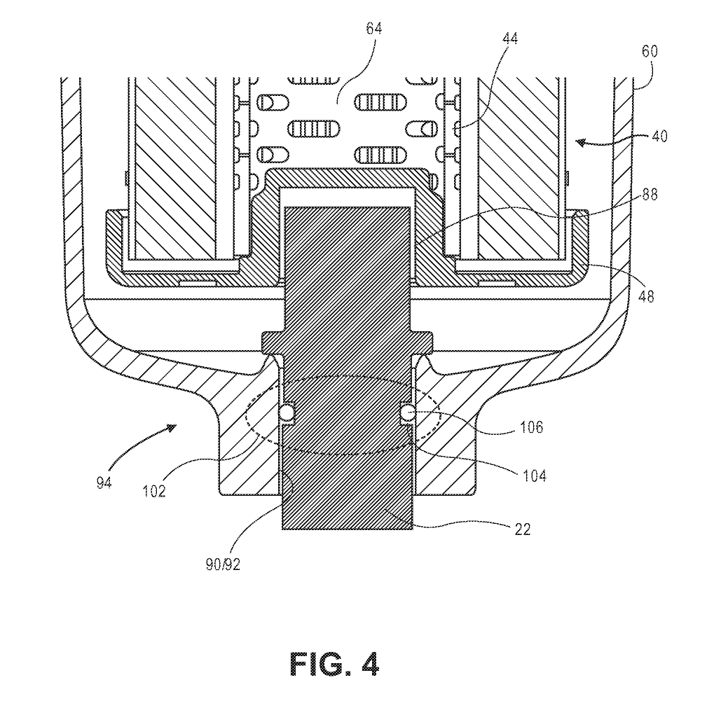

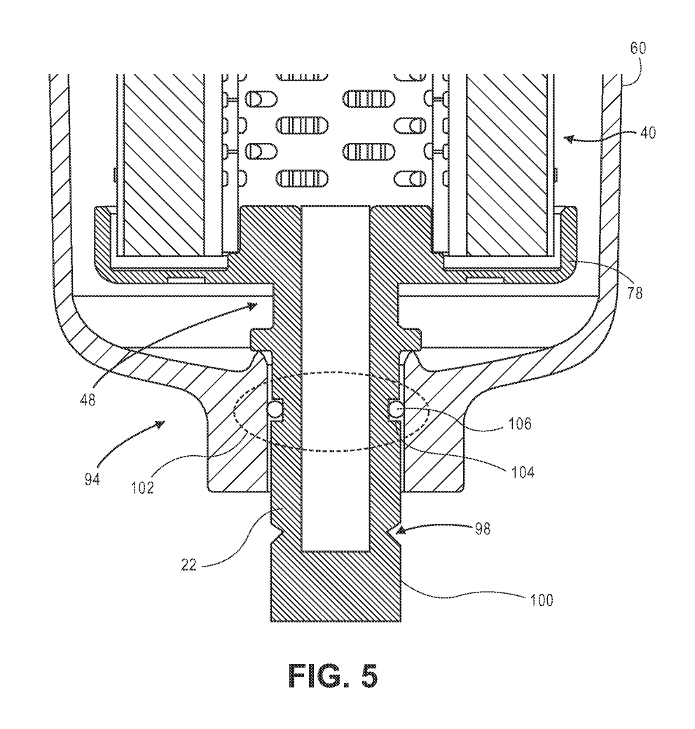

The plug 22, as shown in various examples, may be configured to mate with a bottom plate bore 88 (FIGS. 2 and 4) or, as shown in FIG. 5, the bottom plate 48 may be a unitary member having a bottom plate body 78 and the plug 22 may extend along an axis of elongation from the bottom plate body 78. Regardless of whether the plug 22 is a separate components or unitary with the bottom plate body 78 shown in FIG. 5, the plug 22 is configured to be received in a housing bore 90. The housing bore 90 is defined by a cylindrical wall 92 passing through the housing 60. The plug 22 and surfaces interacting with the plug 22 define a bottom locator 94. In the example shown in FIG. 3, the bottom locator 94 is defined by the plug 22, the bottom plate bore 88, and the housing bore 90. In the example shown in FIG. 5, the bottom locator 94 is defined by the plug 22 and the housing bore 90.

In various examples, the plug 22 may be solid or may include an internal passage 96. In the example shown in FIG. 5, the internal passage 96 is in fluid communication with the interior chamber 64 and the plug 22 includes a pre-score ring 98 configured to facilitate removal of a lower portion 100 of the plug 22. If included, the internal passage 96 and the pre-score ring 98 provide a drain function for the filter housing assembly 20.

Referring to FIGS. 2, 4, and 5, the plug 22 includes a plug seal 102. The cylindrical wall 92 is sufficiently smooth and long enough to slidingly seal with the plug seal 102 disposed on the plug 22. The plug seal 102 includes any suitable type of seal such as, for example, a friction fit, O-ring seal, or the like. In a particular example, the plug seal 102 includes an annular groove 104 disposed about the plug 22 and sized to accept an O-ring 106. The O-ring 106 may include any suitable elastomeric or deformable material. The plug 22 is generally sized to mate with the housing bore 90 at a relatively close tolerance while allowing rotation and/or a sliding motion of the plug 22 within the housing bore 90.

Referring to FIG. 7 is a cross-sectional perspective view taken axially through the filter housing assembly 20, according to an aspect of the disclosure. As shown in FIG. 7, the fuel inlet 62 is an annular opening formed between the opening of the housing 60 and the perimeter of the top plate 46 and is defined by an inside wall of the housing 60 and the outside perimeter of the top plate 46.

Also shown in FIG. 7, the gasket sleeve 86 is configured to slide into the housing 60 telescopically to locate the gasket 84 about the perimeter of the base coupler 58. In the example shown in FIGS. 7 and 8, the gasket 84 is secured to the gasket sleeve 86 by over-molding the gasket 84 onto a gasket sleeve flange 108. Shown in FIG. 8, the gasket sleeve flange 108 includes a series of perforations 110 so that the gasket 84 is integrally secured to the gasket sleeve flange 108 during the over-molding process.

### INDUSTRIAL APPLICABILITY

The present disclosure may be applicable to any machine including a fluid filter. Aspects of the disclosed filter housing assembly may promote ease of use, reduced manufacturing costs, reduced waste in the manufacturing process, operational flexibility, and performance of fluid filter housing assemblies in general and fuel systems in particular. As described herein, it is an advantage of aspects of the filter housing assembly 20 that the top plate 46 is a separate piece from the gasket sleeve 86. For example, the gasket 84 is over-molded on the gasket sleeve 86. This process entails first forming the gasket sleeve 86 and then placing the gasket sleeve 86 into a second mold in which the gasket 84 is molded and integrated onto the gasket sleeve 86. It is more likely that an over-molded component will be rejected during quality control because of the additional steps in the manufacturing process. Also, over-molded components are more difficult to recycle due to the two different materials. By making the gasket sleeve 86 separate from the top plate 46, if the gasket sleeve 86 is rejected, only a relatively low-mass component is rejected and so, material cost can be saved.

It is another advantage of some aspects of the disclosure, that the fuel inlet 62 is unobstructed by conventional webbing spanning between the filter housing and the filter unit. Instead, the fuel inlet 62 is a single, annular opening that may allow greater flow through the fuel inlet 62 and/or may allow the filter unit 40 to be relatively larger—which may increase the service life of the filter unit 40. As shown in FIG. 2, the filter unit 40 is secured or located within the filter housing assembly via the action of the top locator 68 and the bottom locator 94.

It is yet another advantage of some aspects of the disclosure, that the plug 22 may be formed as a single piece. In this manner, the number of components in the filter housing assembly 20 may be reduced. The number of components may be further reduced by integrating the plug 22 into the bottom plate 48 such that the filter unit 40 and the plug 22 are a single component when assembled.

It is yet another advantage of some aspects of the disclosure, that the plug 22 may be utilized to drain the filter housing assembly 20. As shown in FIG. 5, the pre-score ring 98 may provide a fracture point to remove the lower portion 100 from the plug 22 and drain the fuel from the filter housing assembly 20. The breakaway function of the plug 22 provides a single-use drain that may reduce manufacturing costs as well as provide a robust and uncomplicated drain function for the filter unit 40 that may also be a single-use component.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified.

We claim:

1. A filter unit comprising:
a top plate disposed at a first portion of the filter unit;
a bottom plate disposed at a second portion of the filter unit;
a plug extending from the bottom plate along an axis of elongation of the filter unit; and
a filter medium disposed between the top plate and the bottom plate.

2. The filter unit according to claim 1, further comprising:
a bottom plate bore disposed in the bottom plate, the bottom bore configured to receive the plug.

3. The filter unit according to claim 1, further comprising:
a center tube disposed between the top plate and the bottom plate, the filter medium being disposed about the center tube and the center tube defining an interior chamber.

4. The filter unit according to claim 3, further comprising:
a pre-score ring annularly disposed about the plug;
a bottom portion of the plug being distal from the bottom plate and the pre-score ring being disposed between the bottom portion of the plug and a remainder of the plug; and
an internal passage disposed along an axis of elongation through the plug, the internal passage being in fluid communication with the interior chamber of the filter unit and the internal passage terminating within the bottom portion of the plug.

5. The filter unit according to claim 3, further comprising:
a fluid outlet disposed through the top plate and in fluid communication with the interior chamber.

6. The filter unit according to claim 5, further comprising:
an alignment cone extending from a lip of the fluid outlet.

7. The filter unit according to claim 1, further comprising:
a gasket disposed about the plug.

8. A housing assembly configured to filter a fluid, the filter housing assembly comprising:
a filter unit including:
a top plate disposed at a first portion of the filter unit, the top plate including a fluid outlet;
a bottom plate disposed at a second portion of the filter unit;
a plug extending from the bottom plate along an axis of elongation of the filter unit; and
a plug gasket disposed about the plug; and
a filter medium disposed between the top plate and the bottom plate; and
a housing including:
a housing bore defined by a cylindrical surface and the plug gasket is configured to form a seal between the cylindrical surface and the plug.

9. The housing assembly according to claim 8, further comprising:
a bottom plate bore disposed in the bottom plate, the bottom bore configured to receive the plug.

10. The housing assembly according to claim 8, further comprising:
a center tube disposed between the top plate and the bottom plate, the filter medium being disposed about the center tube and the center tube defining an interior chamber.

11. The housing assembly according to claim 10, further comprising:
a pre-score ring annularly disposed about the plug;
a bottom portion of the plug being distal from the bottom plate and the pre-score ring being disposed between the bottom portion of the plug and a remainder of the plug; and
an internal passage disposed along an axis of elongation through the plug, the internal passage being in fluid communication with the interior chamber of the filter unit and the internal passage terminating within the bottom portion of the plug.

12. The housing assembly according to claim 8, further comprising:
an alignment cone extending from a lip of the fluid outlet.

13. A filter system configured to filter a fluid, the filter system comprising:
a filter base including:
a base inlet;
a base outlet;
a connection port; and
a housing coupler; and
a filter housing assembly including:
a base coupler configured to mate to the housing coupler;
a filter unit including:
a top plate disposed at a first portion of the filter unit, the top plate including a fluid outlet configured to mate with connection port to form a top locator;
a bottom plate disposed at a second portion of the filter unit;
a plug extending from the bottom plate along an axis of elongation of the filter unit; and
a plug gasket disposed about the plug; and
a filter medium disposed between the top plate and the bottom plate; and
a housing including:
a housing bore defined by a cylindrical surface and the plug gasket is configured to form a seal between the cylindrical surface and the plug.

14. The filter system according to claim 13, further comprising:
a bottom plate bore disposed in the bottom plate, the bottom bore configured to receive the plug.

15. The filter system according to claim 13, further comprising:
a center tube disposed between the top plate and the bottom plate, the filter medium being disposed about the center tube and the center tube defining an interior chamber.

16. The filter system according to claim 15, further comprising:
a pre-score ring annularly disposed about the plug;
a bottom portion of the plug being distal from the bottom plate and the pre-score ring being disposed between the bottom portion of the plug and a remainder of the plug; and
an internal passage disposed along an axis of elongation through the plug, the internal passage being in fluid communication with the interior chamber of the filter unit and the internal passage terminating within the bottom portion of the plug.

17. The filter system according to claim 13, further comprising:
an alignment cone extending from a lip of the fluid outlet.

18. The filter system according to claim 13, further comprising:
a filter system gasket disposed between the housing coupler and the base coupler.

19. The filter system according to claim 18, further comprising:
a gasket sleeve affixed to the filter system gasket and configured to cooperatively align the filter system gasket on the base coupler.

20. The filter system according to claim 18, further comprising:
a gasket sleeve flange extending radially from the gasket sleeve along a plane defined by a top edge of the gasket sleeve, the gasket being over-molded onto the gasket sleeve flange.
